(19) United States
(12) Patent Application Publication
(10) Pub. No.: US 2023/0052613 A1
(43) Pub. Date: Feb. 16, 2023

(54) METHODS AND SYSTEMS FOR OBTAINING A SCALE REFERENCE AND MEASUREMENTS OF 3D OBJECTS FROM 2D PHOTOS

(71) Applicants: Jin Chong KOH, Las Vegas, NV (US); Visualize K.K., New York, NY (US)

(72) Inventors: Kyohei Kamiyama, Tokyo (JP); Chong Jin Koh, Las Vegas, NV (US)

(21) Appl. No.: 17/794,255

(22) PCT Filed: Jan. 22, 2021
(86) PCT No.: PCT/US2021/014549

§ 371 Date: Jul. 21, 2022

Related U.S. Application Data
(60) Provisional application No. 62/964,562, filed on Jan. 22, 2020.

(51) Int. Cl. G06T 19/20; H04N 5/232; G06T 7/60; G06T 17/20

(52) U.S. Cl. CPC G06T 19/20; H04N 5/23222; G06T 7/60; G06T 17/20; G06T 2207/10028; G06T 2219/2016; G06T 2219/004; G06T 2210/44; G06T 2207/30196; G06T 2207/20084

(57) ABSTRACT

Disclosed are systems and methods for obtaining a scale factor and 3D measurements of objects from a series of 2D images. An object to be measured is selected from a menu of an Augmented Reality (AR) based measurement application being executed by a mobile computing device. Measurement instructions corresponding to the selected object are retrieved and used to generate a series of image capture screens. A series of image capture screens assist the user in positioning the device relative to the object in a plurality of imaging positions to capture the series of 2D images. The images are used to determine one or more scale factors and to build a complete scaled 3D model of the object in virtual 3D space. The 3D model is used to generate one or more measurements of the object.

### FIELD OF THE INVENTION

Embodiments of the invention are in the field of deriving 3D measurements of objects from 2D photos using mobile computing devices, such as smartphones or tablet devices.

### BACKGROUND OF THE INVENTION

The statements in the background of the invention are provided to assist with understanding the invention and its applications and uses, and may not constitute prior art.

Photogrammetry relates to obtaining three-dimensional (3D) information about 3D objects through recording and synthesizing data from two-dimensional (2D) images. In some implementations, photogrammetry enables obtaining 3D information from 2D photographs or images. Photogrammetry makes use of methodologies drawn from different disciplines, such as optics, projective geometry, and so on, in order to synthesize 3D information from 2D images.

However, photogrammetry requires a known scale factor or other dimensionality data in order to generate an accurate 3D model with proper dimensional information. Therefore, it would be an advancement in the state of the art to determine a scale factor of 2D photos, and use the scale factor during the photogrammetry process to generate a 3D model of the object. Furthermore, it would be a further advancement in the state of the art to allow mobile computing devices to obtain 3D measurements of 3D objects from 2D photos.

It is against this background that the present invention was developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Photogrammetry enables obtaining measurements for 3D objects from 2D images. A scale factor is the ratio of the size or distance of a feature on an image to its actual real-world size. If the scale factor of an image is known, the actual real-world measurements, distances, or lengths of objects can be calculated by measuring the corresponding distances on the photo in pixel dimensions and multiplying them by the scale factor. As object detection and recognition technologies improve, the mobile computing devices can be used for obtaining measurements of different objects, provided a physical scale exists to serve as a size reference. Generally, reference objects such as A4 size sheets or credit cards, which have known sizes with standardized dimensions, are employed for obtaining the scale factor. However, having to ensure the availability of such objects at the time of measurement increases user resistance to employing the mobile computing devices for measurements. Therefore, obtaining the scale factor without the use of reference objects of known size would be highly desirable from the user's perspective and the corresponding adoption of the user application.

A scale factor scales the dimensions of a 2D image of a target object from pixel dimensions to real world dimensions. There exists a distinct scale factor for each of the distinct 2D images of the target object captured by a device. The terms scale reference and scale information refer to one or more such scale factors enabling the generation of a scaled 3D model.

Various methods and algorithms are within the scope of the present invention for determining a scale reference. In one embodiment, a software library on the mobile computing device is used to detect at least two features points of a ground plane on which the target object is placed. The feature points thus detected are used to determine a scale reference, as detailed below. In another embodiment, a depth sensor is used to determine the scale reference. In yet another embodiment, a lidar sensor (i.e., a laser detection, imaging, and ranging device) is used to determine the scale reference. A depth sensor or lidar may be used to generate depth information (e.g., how far the target object in the 2D image is from the camera) from one or more captured 2D images. Depth information may in turn be used to scale the pixel dimensions of the target object to its real-world dimensions.

Measuring regular objects is easier than measuring irregular objects. Even when a person is physically in possession of the irregular object, obtaining the measurements of irregular objects can require multiple measurements from different angles and usage of different types of measuring tools. Systems and methods are disclosed herein for obtaining measurements of regular and irregular objects using mobile computing devices.

In one embodiment, the mobile computing device can download and execute a measurement application for measuring the object. In an embodiment of the invention, the measurement application is an Augmented Reality (AR) guided scanning application. The mobile computing device is placed at a predetermined position relative to the object so that the camera on board the mobile application is focused on the object. The measurement application is opened and a user operating the mobile computing device is requested to log in. Upon logging in, the user can either select to measure an object or retrieve previously uploaded images. If the user selects to measure an object, the user is provided with object measurement instructions based on the user selection. In order to be measured accurately, the object is imaged from different sides and different angles based on the instructions or directions provided by the measurement application, with the object maintained in the correct position based on the AR guides. Different sets of instructions can be provided for different objects.

In some embodiments, a depth sensor or a lidar sensor is used to determine the scale reference. In another embodiment, a measurement of a horizontal reference plane or a ground plane is initially obtained using an augmented reality software development kit (AR-SDK), or an equivalent library or subroutine on the mobile computing device. For example, an AR-SDK developed for the Apple iPhone and described at http://developer.apple.com/documentation/arkit may be used. Other AR-SKDs may also be used, such as the Android AR-SDK described at https://outsourceit.today/ar-sdk-ios-android-development/. A computer vision software development kit (CV-SDK), or equivalent library or subroutine on the mobile computing device, is used to identify the object to be measured. For example, an CV-SDK developed for the Apple iPhone and described at: https://developer.apple.com/documentation/vision may be used. Other AR-SDKs are further discussed below, in the context of FIG. 4. FIG. 11 shows an illustrative example of a first image capture screen for sensing the ground plane in accordance with the examples disclosed herein.

Based on the identified object, the measurement instructions initially generate a first position guide to capture a first image of the object in a first position. The first position guide can guide the user regarding precise placement of the camera and mobile computing device relative to the object in the first position for capturing the first image. Similarly, a series of images capturing the object from different sides and different angles are obtained by placing the mobile computing device in a series of positions relative to the object, which is generally maintained in the same fixed location. In an example, at least 2 (preferably at least 3) images of the object are captured from at least 2 (or at least 3) different directions and at least 2 (or at least 3) different positions. Based on the ground plane measurement (e.g., feature points) and the different positions, 3D dimensions can be reconstructed from the series of 2D images without the need for a reference object. More particularly, the distance information of at least 2 (or at least 3) feature points in the AR-SDK enables generation of a scale factor, which can be used to scale a 3D model. In an example, scale information can be obtained from the series of 2D images using geometric analysis running in program code. In another example, deep learning networks that are trained on images of similar objects with explicitly labelled scale data can be used to extract scale information from the 2D images and reconstruct a 3D model of the object.

There exists a distinct scale factor scaling pixel dimensions to real-world dimensions for each of the distinct captured 2D images. The terms scale reference and scale information refer to one or more such scale factors enabling the generation of a scaled 3D model.

In one embodiment, a computer-implemented method for obtaining measurements of an object is disclosed, the method executable by a processor, the method comprising generating a plurality of image capture screens for display on a mobile computing device, each image capture screen providing instructions for placing the mobile computing device in corresponding image capture positions for measurement of the object, wherein each of the plurality of image capture positions are within a predetermined angular distance around the object; capturing a plurality of images of the object corresponding to the plurality of image capture screens; determining one or more scale factors for the plurality of images of the object; generating a 3D model of the object from the at least two different images of the plurality of images and their corresponding scale factors, wherein a given scale factor scales pixel dimensions in a given image to real-world dimensions of the object; and generating one or more object measurements from the 3D model.

In one embodiment, determining one or more scale factors for the plurality of images of the object comprises detecting two or more feature points on a ground plane on at least two different images of the plurality of images, and determining a scale factor for each of the at least two different images from the two or more feature points.

In one embodiment, the one or more scale factors are determined using a lidar sensor.

In another embodiment, the one or more scale factors are determined using a depth sensor.

In yet another embodiment, the processor employs an augmented reality software development kit (AR-SDK) for detecting the ground plane.

In one embodiment, the one or more scale factors are calculated based on distances between at least three feature points of the ground plane.

In one embodiment, generating the 3D model of the object further comprises utilizing a 2D keypoint Deep Learning Network (DLN).

In another embodiment, generating the 3D model of the object further comprises utilizing a 3D keypoint Deep Learning Network (DLN).

In yet another embodiment, the 3D model is generated using a retopology process.

In one embodiment, one or more of the image capture screens enables a user employing the mobile computing device to set a relative position between the object and the mobile computing device into one of the image capture positions.

In one embodiment, the image capture screens for setting the image capture positions comprise a position guide for positioning the object.

In another embodiment, one or more of the plurality of image capture screens enable determining an angle of the mobile computing device relative to the object in each of the image capture positions.

In one embodiment, one or more of the plurality of image capture screens enable determining whether there is movement of the mobile computing device during an image capture operation.

In yet another embodiment, the mobile computing device generates feedback when the mobile computing device is in a correct imaging position.

In one embodiment, the object is a body part.

In another embodiment, the body part is a human limb.

In another embodiment, the body part is selected from the group comprising a human foot and a human hand.

In one embodiment, the computer-implemented method further comprises receiving a selection of an object type to be measured from a plurality of object types, wherein the image capture screens are generated based on the selected object type.

In various embodiments, a computer program product is disclosed. The computer program may be used for obtaining scale reference and measurements of a three-dimensional (3D) object from a series of 2D images of the 3D object, and may include a computer-readable storage medium having program instructions, or program code, embodied therewith, the program instructions executable by a processor to cause the processor to perform steps to the aforementioned steps.

In various embodiments, a system is described, including a memory that stores computer-executable components, and a hardware processor, operably coupled to the memory, and that executes the computer-executable components stored in the memory, wherein the computer-executable components may include components communicatively coupled with the processor that execute the aforementioned steps.

In another embodiment, the present invention is a non-transitory, computer-readable storage medium storing executable instructions, which when executed by a processor, causes the processor to perform a process for generating scale references of 3D objects, the instructions causing the processor to perform the aforementioned steps.

in another embodiment, the present invention is a system for generation of scale references and size measurement of 3D objects using a 2D phone camera, the system comprising a user device having a 2D camera, a processor, a display, a first memory; a server comprising a second memory and a data repository; a telecommunications-link between said user device and said server; and a plurality of computer codes embodied on said first and second memory of said user-device and said server, said plurality of computer codes which when executed causes said server and said user-device to execute a process comprising the aforementioned steps.

In yet another embodiment, the present invention is a computerized server comprising at least one processor, memory, and a plurality of computer codes embodied on said memory, said plurality of computer codes which when executed causes said processor to execute a process comprising the aforementioned steps. Other aspects and embodiments of the present invention include the methods, processes, and algorithms comprising the steps described herein, and also include the processes and modes of operation of the systems and servers described herein.

Yet other aspects and embodiments of the present invention will become apparent from the detailed description of the invention when read in conjunction with the attached drawings.

### BRIEF DESCRIPTION OF THE DRAWINGS

Embodiments of the present invention described herein are exemplary, and not restrictive. Embodiments will now be described, by way of examples, with reference to the accompanying drawings, in which:

FIGS. 1, 2, and 3 show schematic diagrams of three illustrative processes for generating a scale reference and measurements from images of a target object in accordance with exemplary embodiments of the present invention.

FIG. 4 shows an overview schematic diagram of an object measurement system in accordance with one embodiment of the present invention.

FIG. 5 shows a flowchart that details a process of obtaining a scale reference and measurements of a 3D object in accordance with the examples disclosed herein.

FIG. 6 shows a flowchart that details the initial steps of the imaging process in accordance with the examples disclosed herein.

FIG. 7 shows a flowchart that details the imaging process in accordance with the examples disclosed herein.

FIG. 8 shows a diagram of a keypoint DLN architecture for detecting keypoints in 2D images using deep learning, according to one illustrative embodiment of the present invention.

FIG. 9 shows a flowchart detailing an example of a retopology method for constructing a structured 3D model using a base mesh, according to one illustrative embodiment of the present invention.

FIG. 10 shows a flow diagram showing an illustrative user flow through one or more graphical user interfaces (GUIs) implementing one embodiment of the present invention.

FIG. 11 shows an example of a first image capture screen for sensing the ground plane (i.e., horizontal reference surface) in accordance with the examples disclosed herein.

FIG. 12 shows the various image capturing screens that are generated in accordance with the examples disclosed herein.

FIG. 13 shows a diagram with different image capture positions for a naked foot in accordance with an example.

FIG. 14 shows the various image capture positions for the mobile computing device placed in the locations shown in FIG. 13, in accordance with the examples disclosed herein.

FIG. 15 shows the graphical user interfaces (GUIs) that guide the user regarding an imaging angle in accordance with the examples disclosed herein.

FIG. 16 shows an illustrative hardware architecture diagram of a server for implementing one embodiment of the present invention.

FIG. 17 shows an illustrative system architecture for implementing one embodiment of the present invention.

### DETAILED DESCRIPTION OF THE INVENTION

With reference to the figures provided, embodiments of the present invention are now described in detail.

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

This application is related to PCT application No. PCT/US20/70465, filed on 27 Aug. 2020, and entitled “METHODS AND SYSTEMS FOR PREDICTING PRESSURE MAPS OF 3D OBJECTS FROM 2D PHOTOS USING DEEP LEARNING,” the entire disclosure of which is hereby incorporated by reference in its entirety herein.

Obtaining a Scale Factor and Measurements of 3D Objects from 2D Images

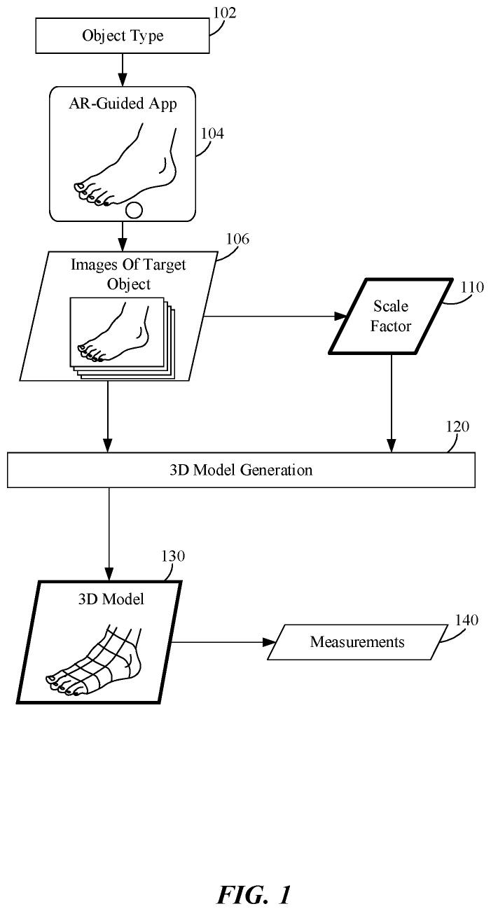

FIGS. 1, 2, and 3 show schematic diagrams of three illustrative processes for generating a scale reference and measurements from images of a target object in accordance with exemplary embodiments of the present invention.

In FIG. 1, an AR-guided (or AR scan) application 104 within a mobile computing device is used as an interface to receive an object type 102 and to generate images (or photos) of a target object 106. Object types depend on the field of the application and may include, for example, various body parts (e.g., hand, foot, face), furniture items, vehicles, retail products (e.g., clothing, food items), etc. An object may therefore be a body part, a living thing, or an inanimate object of any type. The AR-guided app 104 does not collect a scale factor for distance normalization purposes from the user. Instead, the images 106 collected through the AR-guided application 104 are used for scale factor determination.

In some embodiments, a depth sensor or a lidar sensor is used to determine the scale reference. In another embodiment, a ground plane on which the object is placed is initially scanned by the AR-guided application 104. Subsequent image capture screens assist the user in positioning the mobile computing device relative to the object in a plurality of imaging positions to capture a series of 2D images of the target object 106. In one embodiment, the ground plane is represented as three or more feature points in the captured 2D images 106. In one embodiment, the AR-guided application uses a software library (e.g., AR-SDK on iPhone or Android) to determine the real-world coordinates of two or more of the detected ground plane feature points, as discussed above. The AR-SDK provides both the image coordinates and the corresponding real-world coordinates to the processor. From the image coordinates and the corresponding real-world coordinates of at least two feature points on the ground plane, the processor calculates the corresponding scale factor for each image. The captured 2D images 106 are thus used to determine one or more scale factors 110 (i.e., a scale reference) scaling the pixel dimensions of the target object to its real-world dimensions. In one embodiment, a scale reference can be obtained from the series of 2D images using geometric analysis running in program code.

A 3D model generation module 120 uses the one or more determined scale factors 110 and the 2D images of the target object 106 to build a scaled 3D model 130 of the target object in virtual 3D space. A scale factor 110 is required to scale from pixel dimensions in the 2D images to real-world dimensions. In particular, the scale factor 110 allows the scaling of the meshes within the 3D model generation module 120 to real-world dimensions. The scaled 3D model 130 is subsequently used to generate one or more measurements 140 of the target object.

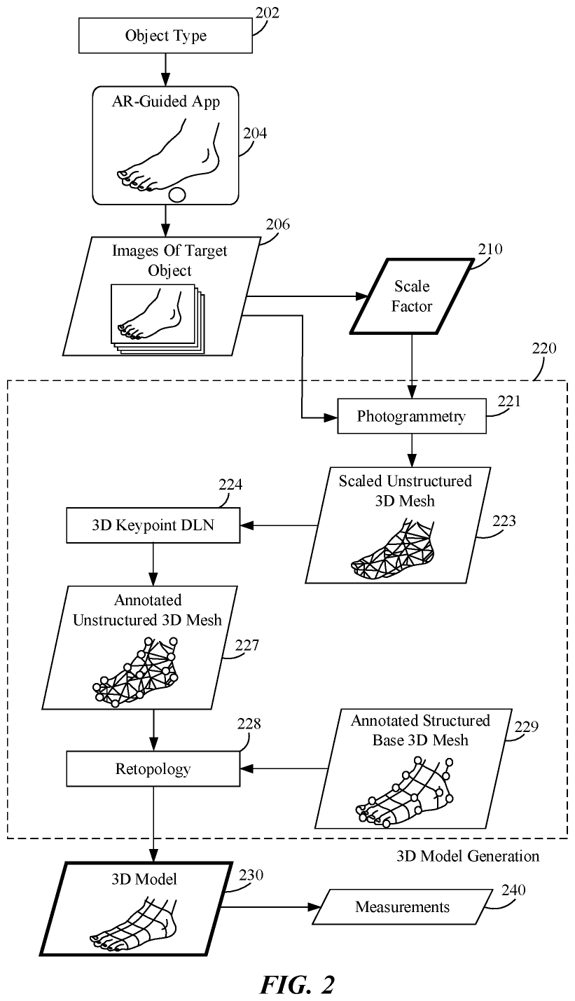

Importantly, scale reference 110 determination and 3D model 130 building may be implemented on the mobile computing device or in the cloud (e.g., on a remote server), as mentioned in the context of FIG. 4.

FIGS. 2 and 3 show two exemplary embodiments of the present invention where the 3D model generation 120 process discussed above is further detailed. In FIG. 2, the 3D model generation process uses a 3D keypoint Deep Learning Network (DLN), whereas a 2D keypoint DLN is used in the embodiment of FIG. 3.

In the embodiment of FIG. 2, an AR-guided application 204 within a mobile computing device is used as an interface to receive an object type 202 and to generate images of a target object 206. The AR-guided app 204 does not collect a scale factor for distance normalization purposes from the user. Instead, the images 206 collected through the AR-guided application 204 are used for scale factor determination.

In some embodiments, a depth sensor or a lidar sensor is used to determine the scale reference. In another embodiment, a ground plane on which the object is placed is initially scanned by the AR-guided application 204. Subsequent image capture screens assist the user in positioning the mobile computing device relative to the object in a plurality of imaging positions to capture a series of 2D images of the target object 206. In one embodiment, the ground plane is represented as three or more feature points in the captured 2D images 206. In one embodiment, the AR-guided application uses a software library to determine the real-world coordinates of two or more of the detected ground plane feature points, as discussed above. The captured 2D images 206 are thus used to determine one or more scale factors 210 (i.e., a scale reference) scaling the pixel dimensions of the target object to its real-world dimensions.

The 3D model generation module 220 uses the one or more determined scale factors 210 and the 2D images of the target object 206 to build a scaled and structured 3D model 230 of the target object in virtual 3D space. A scale factor 210 is required to scale from pixel dimensions in the 2D images to real-world dimensions. In particular, the scale factor 210 allows the scaling of the meshes within the 3D model generation module 220 to real-world dimensions.

Structured and unstructured meshes differ by their connectivity. An unstructured mesh has irregular connectivity between vertices, requiring the explicit listing of the way vertices make up individual mesh elements. Unstructured meshes therefore allow for irregular mesh elements but require the explicit storage of adjacent vertex relationships, leading to lower storage efficiency and lower resolution. A structured mesh, however, has regular connectivity between its vertices (i.e., mesh elements and vertex distances are predefined), leading to higher space and storage efficiency, and superior resolution. The 3D models 130, 230, 330 generated by the 3D model generation modules 120, 220, 320, are scaled and structured meshes.

In the embodiment of FIG. 2, the images 206 and one or more scale factors 210 generated through the AR-guided app 204 are sent to the 3D model generation module 220 to generate a scaled and structured 3D model 230 of the target object. In the embodiment described in FIG. 2, the 3D model generation module 220 carries out three major operations: photogrammetry 221, 3D keypoint detection 224, and retopology 228. Photogrammetry 221 uses the input photos of the target object 206 and the scale factor 210 to generate a scaled unstructured 3D mesh 223 representing the object in three dimensions. Photogrammetry 221 is described in more detail in PCT application No. PCT/US20/70465, which is hereby incorporated by reference in its entirety herein as if fully set forth herein. The scaled unstructured mesh 223 generated by the photogrammetry 221 process is then fed to a 3D keypoint DLN 224.

Keypoint annotation is the process of annotating the scaled unstructured mesh 223 by detecting keypoints within the mesh representation of the 3D object (e.g., on the object surface). The annotation of the unstructured 3D mesh is required as an initial stage in the generation of the structured 3D model. Annotation is the generation of annotation keypoints indicating salient features of the target object. Mesh annotations may be carried out through one or more 3D keypoint DLN modules that have been trained on a specific object type (e.g., a specific body part).

The keypoint detection process falls under the broad category of landmark detection. Landmark detection is a category of computer vision applications where DLNs are commonly used. Landmark detection denotes the identification of salient features in 2D or 3D imaging data and is widely used for purposes of localization, object recognition, etc. Various DLNs such as PointNet, FeedForward Neural Network (FFNN), Faster Regional Convolutional Neural Network (Faster R-CNN), and various other Convolutional Neural Network (CNNs) were designed for landmark detection. The 3D keypoint DLN 224 can be based on any 3D landmark detection machine learning algorithm, such as a PointNet.

PointNets are highly efficient DLNs that are applied in 3D semantic parsing, part segmentation, as well as classification. PointNets are designed to process point clouds directly, hence allowing effective 3D landmark detection. PoitnNets also avoid unnecessary transformations of the unstructured 3D mesh input. In one embodiment, the PointNet algorithm is implemented as described in Charles R. Qi, et al., “PointNet: Deep Learning on Point Sets for 3D Classification and Segmentation,” CVPR 2017, Nov. 9, 2017, available at arXiv: 1612.00593, which is hereby incorporated by reference in its entirety herein as if fully set forth herein. PointNets are only illustrative DLN algorithms that are within the scope of the present invention, and the present invention is not limited to the use of PointNets. Other DLN algorithms are also within the scope of the present invention. For example, in one embodiment of the present invention, a convolutional neural network (CNN) is utilized as a 3D keypoint DLN 224 to extract object keypoints and to annotate meshes.

To carry out 3D keypoint annotation, the 3D keypoint DLN 224 must be trained beforehand using training data sets comprising object meshes and corresponding keypoint annotations. Keypoint annotation DLNs can be trained to detect keypoints for a specific type of object. The 3D keypoint annotation DLN produces an annotated unstructured 3D mesh 227.

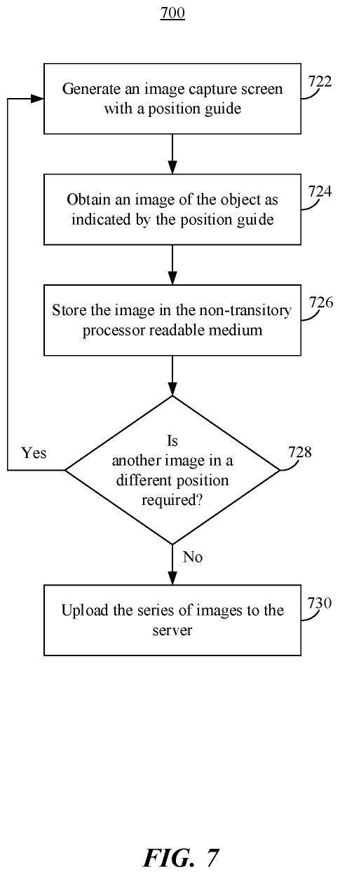

The retopology process 228 uses the annotated unstructured 3D mesh 227 alongside an annotated structured base 3D mesh 229 to generate a scaled structured 3D model 230. Retopology 228 is a morphing process that deforms the shape of an existing structured and annotated base 3D mesh 229 of the object into a structured 3D model 230 of the target object so that its keypoints match the keypoints detected on the object by the 3D keypoint DLN 224 (and represented by the annotated unstructured 3D mesh 227). Retopology may also operate on the mesh surface or projected two-dimensional contour, as discussed in the context of FIG. 9.

The base 3D mesh 229 is a raw 3D mesh representation of the object that is stored on a server or within the device. The retopology process 228 can access a library of 3D base meshes containing at least one base 3D mesh 229 in the category of the target object. In one embodiment, the base 3D meshes in the library are structured and pre-annotated. The morphing of the base 3D mesh therefore produces a scaled and structured 3D mesh representation 230 of the object. Retopology is further discussed in more detail in the context of FIG. 9.

The scaled and structured 3D model 230 generated by the 3D model generation module 220 is subsequently used to generate one or more measurements 240 of the target object.

FIG. 3 depicts another embodiment of the present invention, where a 2D keypoint DLN 324 is used instead of a 3D keypoint DLN 224 to generate the 3D model 230, 330. In the embodiment of FIG. 3, an AR-guided application 304 within a mobile computing device is used as an interface to receive an object type 302 and to generate images of a target object 306. The AR-guided app 304 does not collect a scale factor for distance normalization purposes from the user. Instead, the images 306 collected through the AR-guided application 304 are used for scale factor determination.

In some embodiments, a depth sensor or a lidar sensor is used to determine the scale reference. In another embodiment, a ground plane on which the object is placed is initially scanned by the AR-guided application 304. Subsequent image capture screens assist the user in positioning the mobile computing device relative to the object in a plurality of imaging positions to capture a series of 2D images of the target object 306. In one embodiment, the ground plane is represented as three or more feature points in the captured 2D images 306. In one embodiment, the AR-guided application uses a software library to determine the real-world coordinates of two or more of the detected ground plane feature points, as discussed above. The captured 2D images 306 are thus used to determine one or more scale factors 310 (i.e., a scale reference) scaling the pixel dimensions of the target object to its real-world dimensions.

The 3D model generation module 320 uses the one or more determined scale factors 310 and the 2D images of the target object 306 to build a scaled and structured 3D model 330 of the target object in virtual 3D space. A scale factor 310 is required to scale from pixel dimensions in the 2D images to real-world dimensions. In particular, the scale factor 310 allows the scaling of the meshes within the 3D model generation module 320 to real-world dimensions.

In the embodiment of FIG. 3, the images 306 and one or more scale factors 310 generated through the AR-guided app 304 are sent to the 3D model generation module 320 to generate a scaled and structured 3D model 330 of the target object. In the embodiment described in FIG. 3, the 3D model generation module 320 carries out four major operations: photogrammetry 321, 2D keypoint detection 324, keypoint projection 326 (denoted “projection”), and retopology 328. As for FIG. 2, photogrammetry 321 uses the input photos of the target object 306 and the scale factor 310 to generate a scaled unstructured mesh 323 representing the object in three dimensions. However, the photogrammetry process 321 also generates camera parameters 322 necessary for accurate keypoint projection 326. Camera parameters 322 may include position parameters (e.g., camera location and rotation) as well as internal parameters such as the camera's focal length, lens distortion, sampling (pixel size), or imaging size (i.e., size of the digital sensor's imaging area). Photogrammetry 321 is described in more detail in PCT application No. PCT/US20/70465, which is hereby incorporated by reference in its entirety herein as if fully set forth herein.

In the embodiment of FIG. 3, the 3D model generation module 320 uses a 2D keypoint DLN 324 to generate keypoints 325 from the input photos 306. In this context, 2D keypoint detection is the process of detecting and extracting keypoints 325 from the 2D photos 306. The generated keypoints indicate salient features of the target object on the 2D photos 306. In the keypoint projection step 326, the generated keypoints 325 are projected onto the scaled unstructured 3D mesh 323, where the camera parameters 322 are used to accurately determine the location of the keypoints 325 in 3D space. The projection step 326 therefore combines the keypoints 325 with the scaled unstructured 3D mesh 323 to generate an annotated unstructured 3D mesh 327.

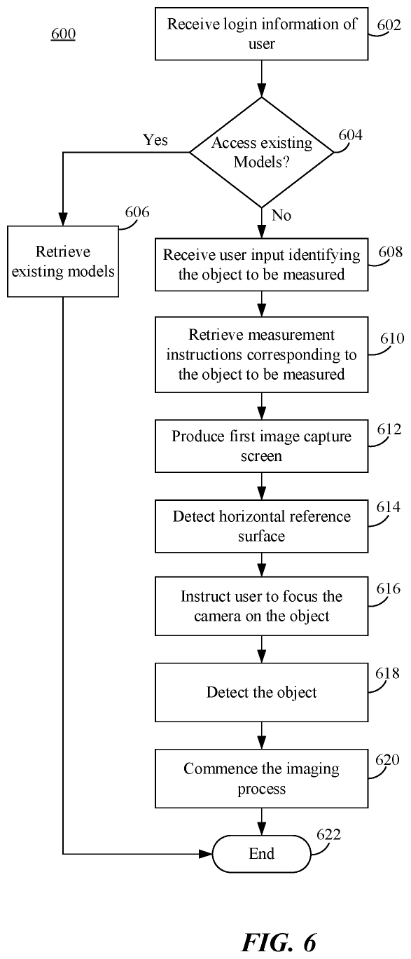

Keypoint generation may be carried out through one or more 2D keypoint DLN modules that have been trained on a specific object type (e.g., human foot). In some embodiments, for example, the segmentation of the object from the background and its annotation may be carried out by two separate DLNs. The 2D keypoint generation process also falls under the category of landmark detection, as discussed above. Various landmark DLNs, such as the Stacked Hourglass Convolutional Neural Network (CNN), HRNet, FeedForward Neural Network (FFNN), Faster Regional Convolutional Neural Network (Faster R-CNN), and other CNNs, may be used to build a 2D keypoint DLN. An exemplary architecture of a Stacked Hourglass CNN is discussed in the context of FIG. 8.

To carry out 2D keypoint annotation, the 2D keypoint DLN 324 must be trained beforehand using training data sets comprising object photos and corresponding keypoints. 2D keypoint DLNs can be trained to detect keypoints for a specific type of object. In some embodiments, segmentation (i.e., the separation of the object from its background) and annotation can be carried out through multiple DLN stages.

As is the case in the embodiment of FIG. 2, the keypoint projection 326 step produces an annotated unstructured 3D mesh 327. Similarly, the retopology process 328 uses the annotated unstructured 3D mesh 327 alongside an annotated structured base 3D mesh 329 to generate a scaled structured 3D model 330. Retopology is further discussed in more detail in the context of FIG. 9.

The scaled and structured 3D model 330 generated by the 3D model generation module 320 is subsequently used to generate one or more measurements 340 of the target object.

The DLN algorithms listed above for the various DLN applications disclosed herein (e.g., Stacked Hourglass) are only illustrative algorithms that are within the scope of the present invention, and the present invention is not limited to the use of the listed DLN algorithms. Other DLN algorithms are also within the scope of the present invention. Moreover, other machine learning (ML) methods may be used instead of or in combination with the various listed DLN algorithms. Other ML algorithms including, but not limited to, regressors, nearest neighbor algorithms, decision trees, support vector machines (SVM), Adaboost, Bayesian networks, fuzzy logic models, evolutionary algorithms, and so forth, are hence within the scope of the present invention.

FIG. 4 shows an overview schematic diagram 400 of an object measurement system in accordance with one embodiment of the present invention. The embodiment of FIG. 4 uses the feature points of a ground plane detected by a software library on two or more images captured by a mobile computing device 410 to determine a scale reference. In other embodiments, a depth sensor or a lidar sensor located on the mobile computing device is used to determine the scale reference. In the embodiment of FIG. 4, the object measurement system 400 includes a mobile computing device 410 which executes an AR guided measurement application 450 stored on a non-transitory, processor-readable storage medium 402 communicatively coupled to a processor 406 included within the mobile computing device 410 which also includes a camera 404 for capturing images. The mobile computing device 410 can also be connected to a server 460 via a communication network 480 such as the internet. The measurement application 450 (or measurement app) assists a user with recording a ground plane and taking a series of photos of the object 430 (e.g., a human foot). 3D Reconstruction with Retopology Deep Learning Network (DLN) is used to reconstruct a 3D model of the object. From the 3D model, any number of measurements including a pressure map may be performed, for example, using a script, to obtain any desired 1D measurement(s) of the object from the 3D model. Also, from the 3D model, one or more object parameters, such as pressure applied by the object on another object may be estimated. Although a foot may be used as an example of the object to be measured, it may be appreciated that different objects can be measured using similar procedures as disclosed herein.

The measurement application 450 is configured to capture a set of images 420 of an object 430 from different directions. In an embodiment of the invention, the set of images 420 obtained by the measurement application 450 are uploaded to a server 460 which analyzes the images using deep learning networks (DLNs) for extracting the measurements which help build 3D models of the object 430. The measurement application 450 includes a reference plane detector 452, an object identifier 454, an image recorder 456 and an image uploader 458. The reference plane detector 452 is based on AR-SDK. AR-SDK includes a set of processor-executable instructions that enable building and running AR applications on various devices wherein digital data is to be used with real-world images to enable various functions. Different types of AR-SDKs are available to build different types of applications such as but not limited to marker applications which function based on identification of certain markers such as bar codes, etc., location-based applications which do not function on markers but instead use GPS data or other position/location data, etc.

Prior to beginning the measurement process, the user may be requested to identify the object 430 to be measured so that the measurement application 450 can retrieve the corresponding measurement instructions 448. In an example, the measurement instructions 448 can be retrieved from the server 460 upon receiving the user input regarding the object 430 to be measured. The measurement instructions 448 provide audio and/or video instructions via a series of image capture screens with corresponding position guides that direct the user regarding the number of images to be captured for the object 430 and the relative positions of the mobile computing device 410 and the object 430 for each of the images.

One important function of AR-SDKs includes 3D image tracking which requires the AR-SDKs to recognize and track 3D objects which includes environment mapping. Many AR-SDKs such as but not limited to, Vuforia, Kudan, ARKit from Apple®, ARCore from Google®, ARToolKit—an open-source tool, etc. are currently in use which offer different functionalities. One of the available AR-SDKs can be employed for the ground plane detection. For example, ARCore works with Java/OpenGL, Unity and Unreal and focuses on functions such as motion tracking using a smartphone's camera to observe feature points in a room. ARCore can determine both the position and orientation of the phone as it moves so that virtual objects can be accurately placed. Similarly, ARCore can detect horizontal surfaces using the same feature points that it uses for motion tracking. As mentioned above, detecting planes is an important function for AR-SDKs as the AR experiences must be anchored to the detected planes. Different kinds of planes such as horizontal planes such as floor, table, ceiling, etc., vertical planes such as doors, walls, etc., or planes of arbitrary orientation such as ramps, etc. can be detected by some of the AR-SDKs.

Once the horizontal reference plane 470 is detected, a marker may be produced on the horizontal reference plane 470 indicating to the user operating the mobile computation device 410 that the measurement application 450 is ready for the next step in the measurement process. The next step includes the object identifier 454 identifying the object 430 to be measured. In an example, custom machine learning (ML) based object recognition models can be trained and employed for the object identifier 454. For example, Region-based convolutional neural networks (R-CNNs) or You Only Look Once (YOLO), etc., are designed for object recognition with the requisite speed in order to be used in real-time as required by the measurement application 450.

Different ML models can be trained to identify different objects that the measurement application 450 is configured to measure so that when the user inputs information regarding the object 430 to be measured, the measurement instructions 448 along with the corresponding ML model for that object are retrieved. Object recognition as implemented by the measurement application 450 can include at least two computer vision tasks—object localization pertaining to locating the object 430 in an image and optionally generating a bounding box around the object and object detection which includes locating the object within the bounding box. Upon localizing the object 430, the image recorder 456 activates the camera 404 to begin collecting the set of images 420. In an example, the image recorder 456 includes a position guide processor 4562 and a viewer 4564. The position guide processor 4562 receives a signal from the object identifier 454 regarding the location of the object 430 and generates a position guide (not shown) on the screen of the mobile computing device 410 for guiding the user regarding the optimum placement of the object 430 within the field of view for the image capture by the camera 404. The viewer 4564 includes a graphical user interface (GUI) for displaying the position guide and adjusting the position guide to signal the correct position for capturing the image of the object 430 in a given position either as a still photograph or a video. A UI element may be activated for capturing the image. When an image of satisfactory quality (e.g., no blurring or occlusions etc.) is captured or recorded, the user can be instructed to move to the next position to capture the next image in another direction and/or distance.

The set of images 420 thus captured can be uploaded to the server 460 for processing by the image uploader 458. The server 460 can include a scale information retriever 462 and a 3D model builder 464. The scale information retriever 462 measures the distance information between at least three feature points in the set of images 420 to generate the scale reference. The scale reference is used to scale the 3D model by the 3D model builder 464. Computer vision tools such as but not limited to Meshroom, Regard3D, etc., can be used to generate the 3D models.

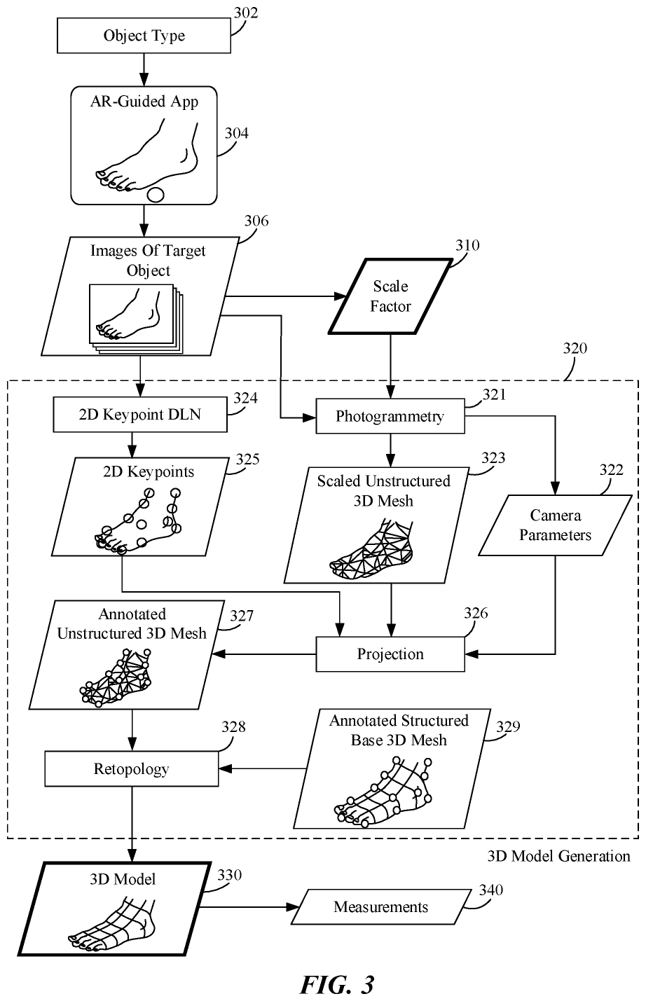

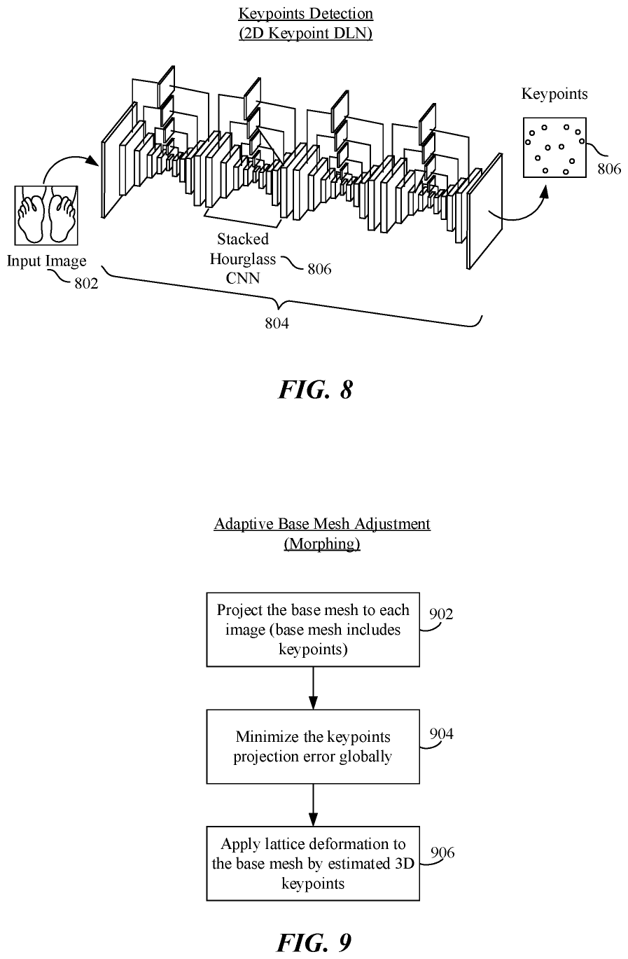

FIG. 5 shows a flowchart that details a process of obtaining a scale reference and one or more measurements of a 3D object in accordance with the examples disclosed herein. At step 502, a plurality of image capture screens is generated for display on a mobile computing device 410, each image capture screen providing instructions for placing the mobile computing device 410 in corresponding image capture positions for measurement of the object. FIGS. 10-15 illustrate examples of capture screens having instructions for the placement of a mobile computing device 410. At step 504, a plurality of images 106 of the object corresponding to the plurality of image capture screens of step 502 is captured. At step 506, two or more feature points on a ground plane on at least two different images of the plurality of images 106 are detected. At step 508, a scale factor 116 is determined for each of the at least two different images from the two or more feature points. At step 510, a 3D model of the object 130 is generated from the at least two different images of the plurality of images and their corresponding scale factors, as discussed above, in the context of FIGS. 1, 2, and 3. At step 512, one or more object measurements 140 are generated from the 3D model. The embodiment described in FIG. 5 uses the feature points of a ground plane detected by a software library on two or more images captured by the mobile computing device 410 to determine a scale reference. In other embodiments, a depth sensor or a lidar sensor located on the mobile computing device is used to determine the scale reference.

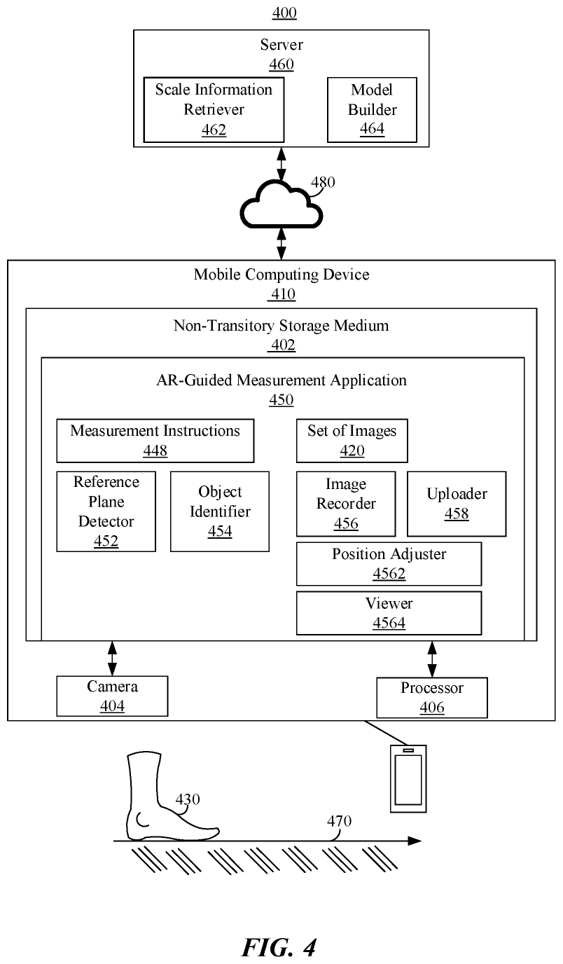

FIG. 6 shows a flowchart 600 that details the initial steps of the imaging process in accordance with the examples disclosed herein. The method begins at 602 wherein the login information of the user for the AR-guided measurement application 450 is received. If the user is authenticated, it is further determined at 604 if there are any existing object models for the user which the user desires to access or if the user wants to measure an object to create a new model. If it is determined at 604 that the user wants to access existing models, the process moves 606 to retrieve existing models and terminates on the end block.

If at 604, the user response indicates that the user desires to create a new model, the process moves to 608 wherein a user input identifying the object 430 or object type 102 to be measured is received. For example, the user may identify a left leg or a right arm or any other object that is to be measured. At 610, the measurement instructions 448 pertaining to the object 430 to be measured are retrieved and a first image capture screen is produced at 612. In an example, the first image capture screen can be used for sensing a horizontal reference surface and accordingly, the user can be instructed to move the mobile computing device 410 so that the camera 404 senses the horizontal reference surface (i.e., the ground plane) on which the object 430 to be measured is placed. The first image capture screen and the accompanying instructions provide directions to the user at 614 to move the mobile computing device 410 so that the horizontal reference surface 470 can be detected. Upon detecting the horizontal reference surface at 614, the user can be instructed via a subsequent object detection screen to focus the camera 404 on the object 430 in the next image capture screen that is generated at 616. The object 430 is detected at 618 and the imaging process to obtain the series of images 420 is commenced at 620. The embodiment described in FIG. 6 uses the feature points of a ground plane detected by a software library on two or more images captured by the mobile computing device 410 to determine a scale reference. In other embodiments, a depth sensor or a lidar sensor located on a mobile computing device 410 is used to determine the scale reference.

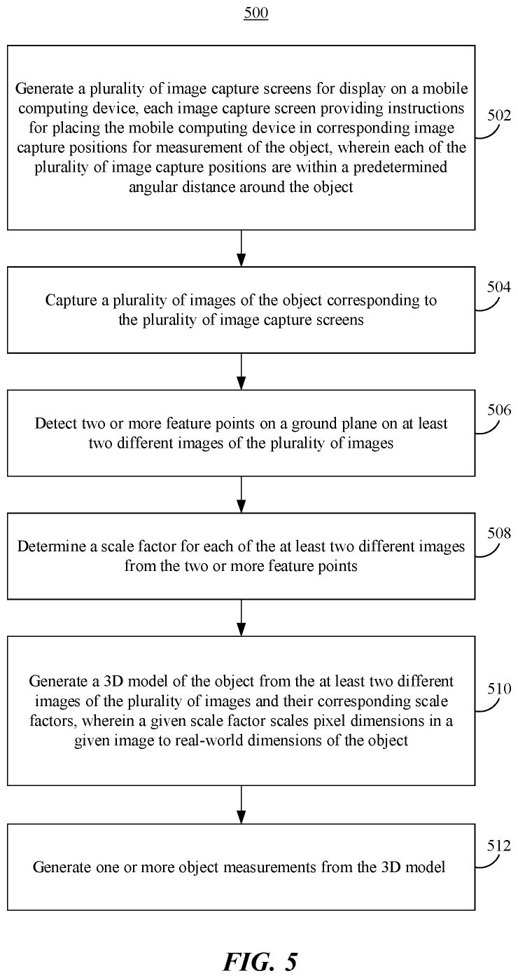

FIG. 7 shows a flowchart 700 that details the imaging process in accordance with the examples disclosed herein. At 722, an image capture screen with a position guide that directs the user regarding the relative positions of the mobile computing device 410 and the object 430 is generated. The image of the object 430 is obtained at 724 with the mobile computing device 410 in a position as indicated by the position guide displayed on the image capture screen. If the quality of the image is satisfactory, the image is stored in the non-transitory, processor-readable storage medium 402 at 726. At 728, it is determined if another image in a different position is required. If at 728, it is determined that a different position is required, the process moves to 722 where a next image capture screen with the corresponding position guide is generated. If at 728, it is determined that another image is not required, the series of images 420 are uploaded to the server at 730. Generally, at least two to three images are needed in order to obtain an accurate scale reference for any object.

Importantly, scale reference 110 determination and 3D model 130 building may be implemented in the cloud (e.g., on a remote server), as described in FIGS. 4 and 7, or locally on the mobile computing device.

### Illustrative 2D Keypoint DLN Architecture and Retopology Process

FIG. 8 shows a diagram of a 2D keypoint DLN 324 architecture for detecting keypoints 325 in 2D photographs (or images) 306 using deep learning, according to one illustrative embodiment of the present invention. FIG. 8 shows an illustrative Stacked Hourglass Convolutional Neural Network (CNN) architecture.

Stacked Hourglass CNNs are landmark detection DLNs that are efficient in detecting patterns such as human pose. They are usually composed of multiple stacked hourglass modules, where each hourglass module has symmetric downsampling and upsampling layers. Consecutive hourglass modules have intermediate supervision, thus allowing for repeated inference between the downsampling and upsampling layers. In one embodiment, the Stacked Hourglass CNN algorithm is implemented as described in Alejandro Newell, et al., “Stacked Hourglass Networks for Human Pose Estimation,” ECCV 2016, Sep. 17, 2016, available at arXiv: 1603.06937, which is hereby incorporated by reference in its entirety herein as if fully set forth herein.

FIG. 8 shows a Stacked Hourglass CNN 804 with four hourglass modules 806. As shown in FIG. 8, a trained stacked hourglass CNN may be used to extract keypoints 806 from an input image 802. To carry out 2D keypoint annotation, a Stacked Hourglass CNN must be trained beforehand using training data sets comprising object photos and corresponding keypoints. Such training data may be obtained through 3D scanned and retopologized object (e.g., foot) data.

The High-Resolution Network (HRNet) is another landmark detection DLN that is a suitable DLN base architecture for the keypoint DLN 112. HRNet are used in human pose estimation, semantic segmentation, and facial landmark detection. HRNets are composed of connected parallel high-to-low resolution convolutions, allowing repeated fusions across parallel convolutions, and leading to strong high-resolution representations. In one embodiment, the HRNet algorithm is implemented as described in Ke Sun, et al., “Deep High-Resolution Representation Learning for Human Pose Estimation,” CVPR 2019, Jan. 9, 2020, available at arXiv: 1902.09212, which is hereby incorporated by reference in its entirety herein as if fully set forth herein.

Stacked Hourglass CNNs and HRNets are only illustrative DLN algorithms that are within the scope of the present invention, and the present invention is not limited to the use of Stacked Hourglass CNNs or HRNets. Other DLN algorithms are also within the scope of the present invention. For example, in one embodiment of the present invention, a convolutional neural network (CNN) is utilized as a keypoint DLN 112 to extract object keypoints 114 from 2D input images or photos 106.

FIG. 9 shows a flowchart detailing an example of a retopology 328 method for constructing a structured 3D model 330 from an annotated unstructured 3D mesh 327 and a base 3D mesh 329, according to one illustrative embodiment of the present invention. The base 3D mesh 329 is a raw 3D mesh representation of the object that is stored on a server (e.g., in the cloud) or within the device. The retopology process 328 can access a library of 3D base meshes containing at least one base 3D mesh 329 in the category of the target object (e.g., object type 302). In one embodiment, the base 3D meshes in the library are structured and pre-annotated. Retopology 328 is a morphing process that morphs an existing structured and annotated base 3D mesh 329 into a structured 3D model 330 of the target object so that its keypoints and its surface match the keypoints 325 and surface of the annotated unstructured 3D mesh 327.

Retopology 328 is therefore an adaptive base mesh adjustment process, as shown in FIG. 9. This process has three major steps. First, in step 902, the keypoints of the base mesh 329 and the unstructured mesh 327 are aligned. Second, in step 904, a new 3D position for each of the keypoints of the base mesh 329 is computed such that a 3D projection error function is minimized. The projection error function is a measure of the deformation, or distance, between the base mesh 329 and the unstructured 3D mesh 327 (i.e., the target mesh), and has at least two terms. The first term of the projection error function is a surface error corresponding to a distance between the surface of the base mesh and the surface of the target mesh. The second term of the projection error function is a keypoint projection error corresponding to a global distance metric between the base mesh keypoints and the target mesh keypoints. The two terms may be weighted in the projection error function using coefficients. Step 904 leads to the definition of a modified set of estimated 3D keypoints for the base mesh 329. Third, in step 906, the base mesh 329 is deformed (i.e., morphed) to match its modified 3D keypoints. The minimization of the projection error function ensures an adhesion of the base mesh to the surface of the target mesh. The morphing of the base mesh 329 results in a scaled and structured 3D mesh representation of the object (i.e., the structured 3D model 330).

Other embodiments of the retopology process may use the input 2D images 306 directly. An alternative embodiment is provided in PCT application No. PCT/US20/70465, which is hereby incorporated by reference in its entirety herein as if fully set forth herein. Different retopology methods can be used repeatedly and iteratively, where the error function is computed for several iterations of the morphed base mesh until a low enough error threshold is achieved.

According to one embodiment, the morphing of structured 3D base meshes through projection error minimization to generate structured 3D models improves on existing photogrammetry processes, and allows for the 3D reconstruction of an object's 3D model using as little as 4-6 photos, in some embodiments, instead of typical photogrammetry processes that might require 40-60 photos.

### Example Use Cases of the Present Invention

FIGS. 10, 11, 12, 13, 14 and 15 are illustrative diagrams of a use case of the present invention in which a mobile device with a single camera and an AR guided scan application 104 is used as an interface for object measurement through the determination of a scale factor, showing mobile graphical user interfaces (GUIs) through which some embodiments of the present invention have been implemented.

FIG. 10 shows a flow diagram 1000 depicting an illustrative user flow through one or more graphical user interfaces (GUIs) implementing one embodiment of the present invention. The target object for measurement in this example is a user's foot.

FIG. 10 shows a splash screen 1002 leading to a login screen 1004 displayed to the user for the measuring application 450 running on the mobile computing device 410. In an example, a username which may include an email and a password is requested from the user for logging in.

FIG. 10 also shows a menu screen 1006 with two menu items which may be displayed upon successful user login. The menu screen 1006 includes two items, an item to capture the set of images labelled “capture foot” and another item to view foot models labelled “View foot models”. When the menu item capture foot is selected, the process to measure a foot as detailed herein is executed in order to capture the set of images 420. When the “view foot models” menu item is selected, images that may have been previously captured are displayed.

FIG. 10 shows an illustrative “captured list” screen 1016 comprising prior uploaded images in accordance with the examples disclosed herein.

In addition to the prior images screen 1016, FIG. 10 shows a “detail” selected image screen 1018 generated in accordance with the embodiments of the invention disclosed herein. The prior images screen 1016 appears when the “view foot models” menu item from the menu screen 1006 is selected. In an example, the prior images screen 1016 or other screens discussed herein can be created in WebView. Different statuses can be associated with the prior images. For example, some of the images shown may be of acceptable quality and are thus saved to the server 460. On the other hand, some of the displayed image slots may indicate that the corresponding images could not be saved to the server 460 due to errors and may need to be retaken. Each of the images on the prior images screen 1016 is individually selectable. The selected image screen 1018 shows an image selected from the plurality of images shown on the prior images screen 1016. Different image effects such as zoom, rotation, move, etc. can be applied to the single image shown on the selected “detail” image screen 1018.

FIG. 10 also shows an object selection screen 1008 generated in accordance with the embodiments of the invention disclosed herein. The object selection screen 1008 can be shown when the “Capture foot” menu item of the menu screen 1006 is selected. The object selection screen 1008 enables selection of a left foot or a right foot for imaging purposes. Selection of one of the objects causes the measurement application 450 to load the measurement instructions corresponding to the selected object and subsequent image capture screens will be shown as configured within the measurement instructions. It may be appreciated that a user foot is selected in the examples above as the object 430 to be measured by way of illustration and not limitation, and that the measurement application 450 may be used for obtaining the measurements of other 3D objects, such as but not limited to hands, faces, heads, furniture, or other animate or inanimate objects, in accordance with the examples disclosed herein.

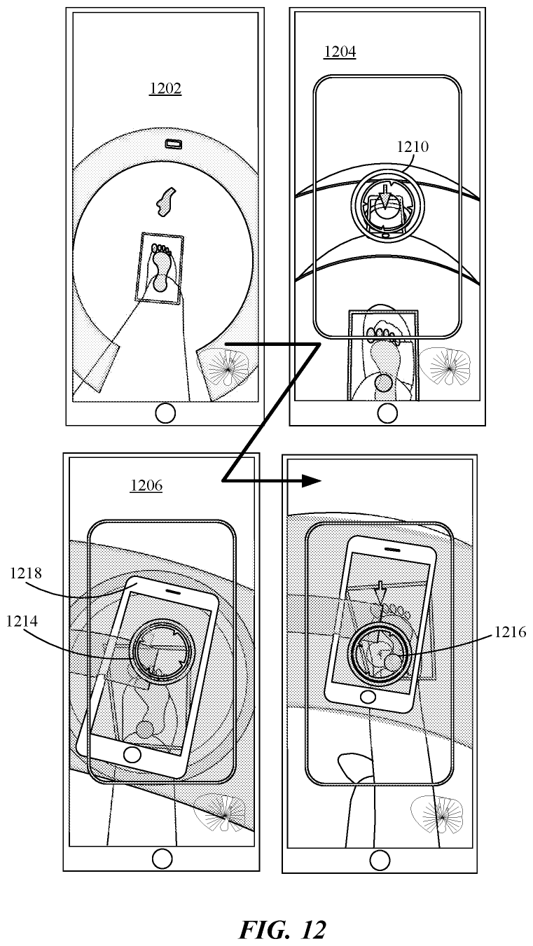

FIG. 10 also shows various image capturing screens 1010 that are generated in accordance with the examples disclosed herein. The capture screens 1010 may be used to sense the horizontal reference surface and guide the user regarding an imaging angle, in accordance with the examples disclosed herein. Image capture in accordance with the examples disclosed herein is further discussed in FIGS. 13, 14, and 15.

FIG. 10 also shows the confirm 1012 and upload 1014 screens wherein the set of images 420 is reviewed before being uploaded to the server 460. The user can review the set of images shown in the confirm screen 1012 to ensure that the images are of good quality without blurring, etc. If any image is found to be faulty, the mobile computing device 410 can be placed in the corresponding imaging position and the image can be retaken. Retaking an image can be carried out by looping back to the select object screen 1008.

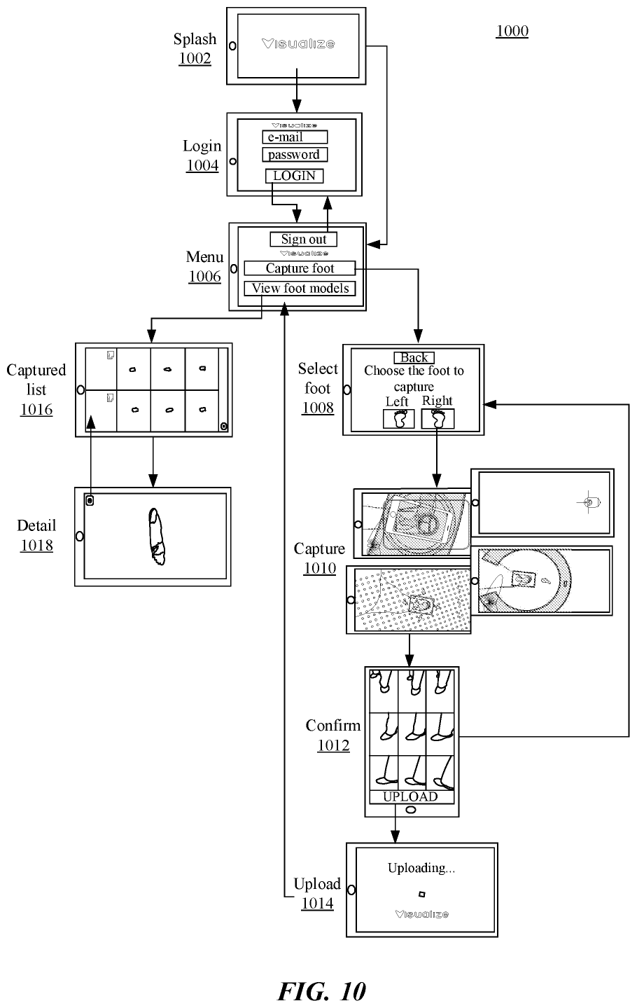

FIG. 11 shows an example of the first image capture screen for sensing the ground plane (or horizontal reference surface). A visual instruction is provided to the user at 1102 to move the device slowly to sense the ground plane. As the mobile computing device 410 records the ground plane, an installation marker 1104 is displayed at the scanned position along with a position guide 1108 for positioning the object. In the example shown in FIG. 11, a foot 1110 to be measured is moved on to the position guide 1108 displayed within the installation marker 1104. The start button 1114 is pressed to capture an image when the foot 1110 is placed within the position guide 1108 as shown at 1116. The embodiment described in FIG. 11 uses the feature points of a ground plane detected by a software library on two or more images captured by the mobile computing device 410 to determine a scale reference. In other embodiments, a depth sensor or a lidar sensor located on a mobile computing device 410 is used to determine the scale reference.

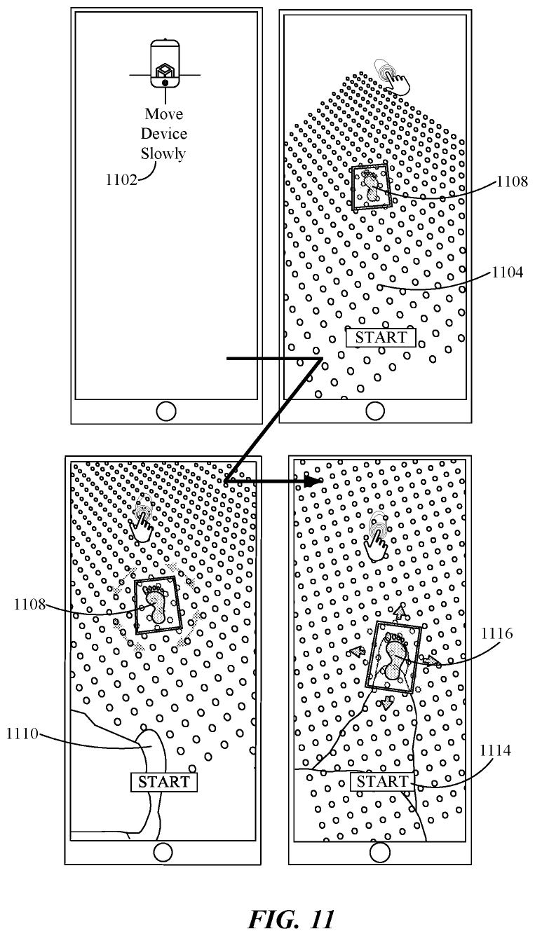

FIG. 12 shows the various image capturing screens that are generated in accordance with the examples disclosed herein. At 1202, the foot 1110 is placed within the position guide 1108 in the image capturing position. At 1204, a visual instruction 1210 to move the mobile computing device 410 vertically downwards towards the foot 1110 is displayed when the camera 404 is switched to an image capture mode when the mobile computing device 410 is within a preconfigured threshold distance of the foot 1110. At 1206, another instruction regarding an angle to be set for the image capture position is provided. It may be noted that the empty circle 1214 in the instruction at 1206 indicates that the mobile computing device 410 is not in the correct position for image capture. The image capture position is indicated at 1206 by the smartphone marker 1218 in the AR space. The arrow at the visual instruction 1210 indicates that the mobile computing device 410 is not within a preconfigured threshold distance from the foot 1110. When the mobile computing device 410 is within a preconfigured threshold distance of the foot 1110, for example, within 40 centimeters, the arrow shown at 1210 may disappear. Moreover, the circle 1216 fills up (e.g., becomes colored), indicating that the position, angle and speed are aligned for image capture based on the data received from the positioning hardware such as the accelerometer, the gyroscope, etc., of the mobile computing device 410. When the mobile computing device 410 is at the image capture position, the image may be automatically captured without the need for the user to activate any button or other UI element in an example. In another embodiment, a capture button may be provided for image capture. As each image of satisfactory quality is captured in an image capture position, the image capture screen for the next position can be automatically loaded by the image recorder 456. If all the images are captured, then a notification to upload the images may be displayed.

FIG. 13 shows a diagram with the different image capture positions 1302 for a naked foot in accordance with an example. The mobile computing device 410 is moved by about 15 degrees for each of the image capture positions 1302. Therefore, a total of 19 images are captured with 9 on each side of the foot starting with the toe 1304 and ending with the heel 1306.

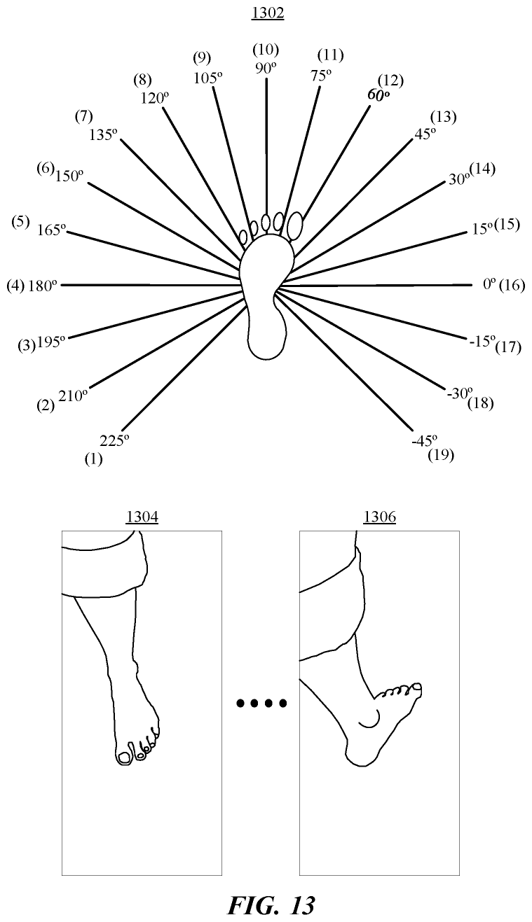

FIG. 14 shows that the various image capture positions shown in FIG. 13 form an ellipse or circle around the foot as shown at 1402. In an example, the ellipse (or circle) may have axes (or a diameter) of about 32 centimeters. An ellipse is generally preferred since it is easier to move the mobile computing device 410 in an elliptical trajectory as compared to a circular trajectory. In an example, the mobile computing device 410 can be held at a height of 32 centimeters as shown at 1404 during each of the 19 image captures. While a higher position may make it easier to take a photograph, the camera angle can make the images unusable for generating a 3D model.

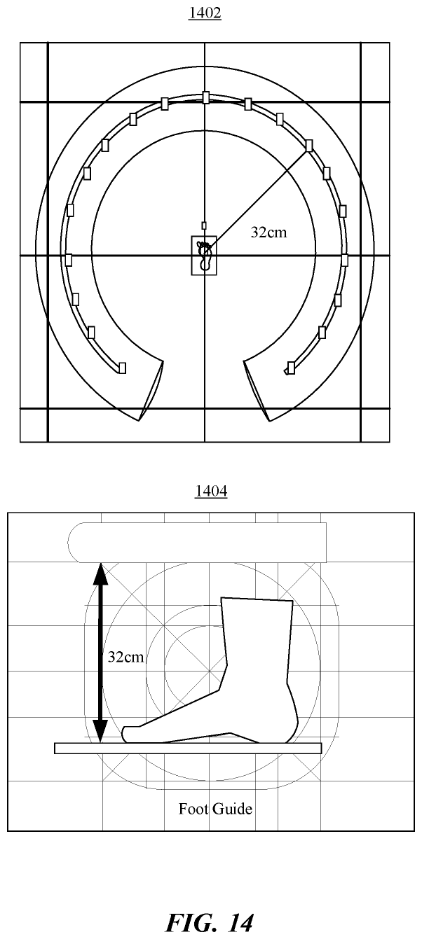

FIG. 15 shows the UIs that can guide the user regarding an imaging angle in which the mobile computing device 410 is to be positioned relative to the object (e.g., foot) being imaged. The imaging angle determines whether a sphere around the foot 1110 placed in the center of the position guide 1510 is at the center of the screen of the mobile computing device 410. While the entire sphere is not shown, an auxiliary target 1504 is displayed and put within the smartphone marker 1218 to determine if it is possible to capture an image of the foot 1110. Prior to capturing the image, the position adjuster 4562 determines if the auxiliary target 1504 fits the center of the screen of the smartphone marker 1218. The foot 1110 to be imaged is centered in the center of the auxiliary target 1504. In an example, the auxiliary target 1504 may have a radius of about 15 centimeters and may be centered 5cm above the surface, as shown in FIG. 15. Smaller angles result in a greater angular adjustment. The position adjuster 4562 determines the optimum position for the foot 1110 based on whether the foot is placed in the center of the auxiliary target 1504. When the imaging position is reached, the auxiliary target 1504 may become colored or flash, or the mobile computing device 410 may generate a notification.

Similarly, the image capture screens can indicate if the mobile computing device 410 is stable enough to capture the set of images 420 without faults such as blurring. Changes in speed or any movement of the mobile computing device 410 can result in a change of colors (or another notification) on the image capture screens. Angular velocity is calculated from the average of the maximum values in the latest 15 frames. In an example, if the velocity as sensed from the hardware on board the mobile computing device 410 such as the accelerometer or the gyroscope, falls below 0.5 units, then it is determined that the mobile computing device 410 is stable enough to execute the image capturing process. This is conveyed to the user using a change in colors or another notification. Additionally, or alternatively, the measurement system 450 may provide vibration feedback when the imaging position is achieved, for example, when the angle, speed and distance from the object 430 are within the thresholds for the imaging position. The term feedback may encompass any other form of notification such as visual and sound notifications. Additionally, or alternatively, a sound may be played when the image is captured. Moreover, in one embodiment, a green circle 1502 (1216 in FIG. 12) fills up indicating that the position, angle and speed are aligned for image capture based on the data received from the positioning hardware such as the accelerometer, the gyroscope, etc., of the mobile computing device 410. It may be appreciated that the various angles, positions and speeds for the image capture positions are described above by way of illustration and not limitation and that other angles, speeds or positions may be used for obtaining the measurements of 3D objects in accordance with the examples disclosed herein.

### Illustrative Photogrammetry Process

Photogrammetry is a process by which a 3D mesh is constructed from a set of 2D photographs or images. The resulting mesh is usually unstructured.

Structured and unstructured meshes differ by their connectivity. An unstructured mesh has irregular connectivity between vertices, requiring the explicit listing of the way vertices make up individual mesh elements. Unstructured meshes therefore allow for irregular mesh elements but require the explicit storage of adjacent vertex relationships, leading to lower storage efficiency and lower resolution. A structured mesh, however, has regular connectivity between its vertices (i.e., mesh elements and vertex distances are predefined), leading to higher space and storage efficiency, and superior resolution.

Various algorithms are within the scope of the present invention for constructing 3D meshes from the 2D photographs. One alternative embodiment in accordance with embodiments of the present invention is described in FIG. 4 of PCT application No. PCT/US20/70465. PCT application No. PCT/US20/70465 is hereby incorporated by reference in its entirety herein as if fully set forth herein. Implementation of other algorithms may involve different steps or processes in the construction of the 3D mesh.

Examples of the 2D photographs and 3D meshes constructed from the 2D photographs by a photogrammetry process are described, in accordance with embodiments of the present invention, in FIG. 5 of PCT application No. PCT/US20/70465, which is hereby incorporated by reference in its entirety herein as if fully set forth herein.

### Hardware, Software, and Cloud Implementation of the Present Invention

As discussed, the data (e.g., photos, textual descriptions, and the like) described throughout the disclosure can include data that is stored on a database stored or hosted on a cloud computing platform. It is to be understood that although this disclosure includes a detailed description on cloud computing, below, implementation of the teachings recited herein are not limited to a cloud computing environment. Rather, embodiments of the present invention are capable of being implemented in conjunction with any other type of computing environment now known or later developed.

Cloud computing can refer to a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics may include one or more of the following. On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

In another embodiment, Service Models may include the one or more ofthe following. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models may include one or more of the following. Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

The cloud computing environment may include one or more cloud computing nodes with which local computing devices used by cloud consumers, such as, for example, personal digital assistant (PDA) or cellular telephone, desktop computer, laptop computer, and/or automobile computer system can communicate. Nodes can communicate with one another. They can be group physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device. It is understood that the types of computing devices are intended to be exemplary only and that computing nodes and cloud computing environment can communicate with any type of computerized device over any type of network and/or network addressable connection (e.g., using a web browser).

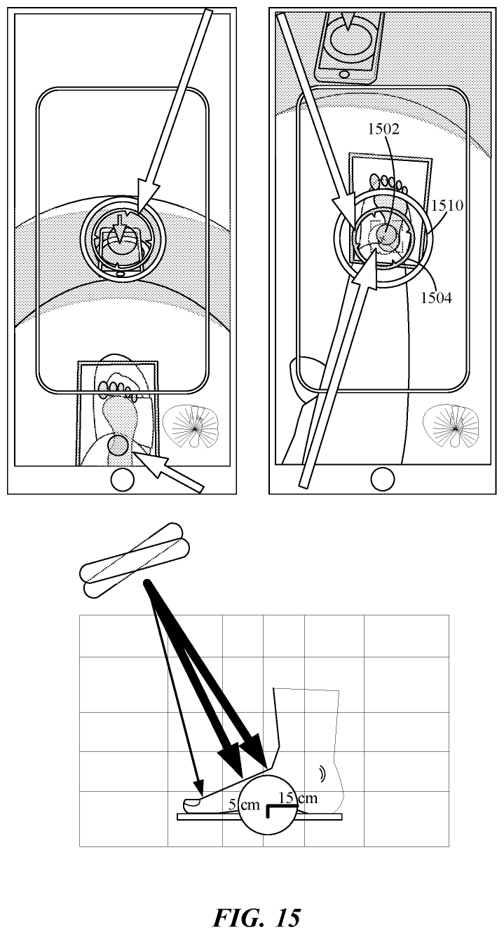

The present invention may be implemented using server-based hardware and software. FIG. 16 shows an illustrative hardware architecture diagram 1600 of a server for implementing one embodiment of the present invention. Many components of the system, for example, network interfaces etc., have not been shown, so as not to obscure the present invention. However, one of ordinary skill in the art would appreciate that the system necessarily includes these components. A user-device is a hardware that includes at least one processor 1640 coupled to a memory 1650. The processor may represent one or more processors (e.g., microprocessors), and the memory may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device.

The hardware of a user-device also typically receives a number of inputs 1610 and outputs 1620 for communicating information externally. For interface with a user, the hardware may include one or more user input devices (e.g., a keyboard, a mouse, a scanner, a microphone, a web camera, etc.) and a display (e.g., a Liquid Crystal Display (LCD) panel). For additional storage, the hardware may also include one or more mass storage devices 1690, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware may include an interface one or more external SQL databases 1630, as well as one or more networks 1680 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces to communicate with each other.

The hardware operates under the control of an operating system 1670, and executes various computer software applications 1660, components, programs, codes, libraries, objects, modules, etc. indicated collectively by reference numerals to perform the methods, processes, and techniques described above.

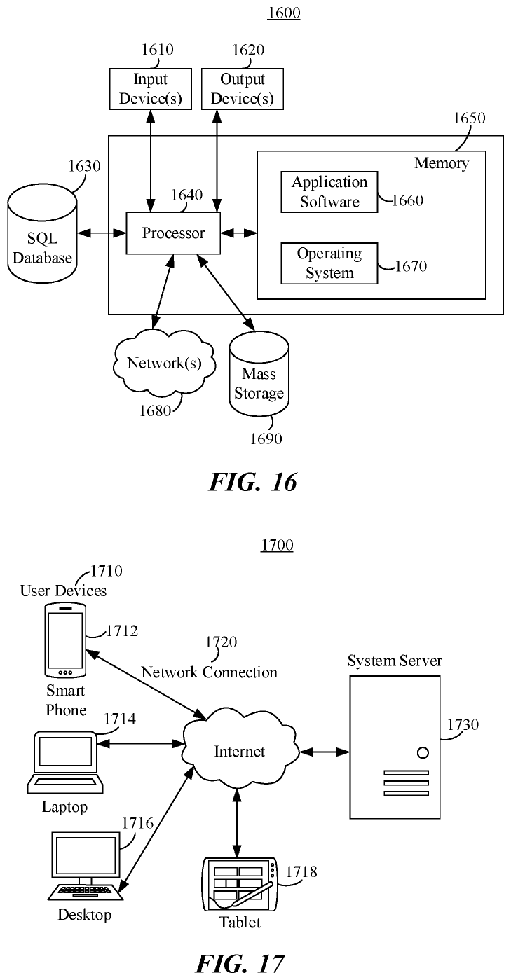

The present invention may be implemented in a client server environment. FIG. 17 shows an illustrative system architecture 1700 for implementing one embodiment of the present invention in a client server environment. User devices 1710 on the client side may include smart phones 1712, laptops 1714, desktop PCs 1716, tablets 1718, or other devices. Such user devices 1710 access the service of the system server 1730 through some network connection 1720, such as the Internet.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service) and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module or sequence of instructions referred to as “computer program(s)” or “computer code(s).” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), and digital and analog communication media.

One of ordinary skill in the art knows that the use cases, structures, schematics, and flow diagrams may be performed in other orders or combinations, but the inventive concept of the present invention remains without departing from the broader scope of the invention. Every embodiment may be unique, and methods/steps may be either shortened or lengthened, overlapped with the other activities, postponed, delayed, and continued after a time gap, such that every user is accommodated to practice the methods of the present invention.

Although the present invention has been described with reference to specific exemplary embodiments, it will be evident that the various modification and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

What is claimed is:

1. A computer-implemented method for obtaining measurements of an object, the method executable by a processor, the method comprising:
generating a plurality of image capture screens for display on a mobile computing device, each image capture screen providing instructions for placing the mobile computing device in corresponding image capture positions for measurement of the object, wherein each of the plurality of image capture positions are within a predetermined angular distance around the object;
capturing a plurality of images of the object corresponding to the plurality of image capture screens;
determining one or more scale factors for the plurality of images of the object;
generating a scaled 3D model of the object from at least two different images of the plurality of images and their corresponding scale factors utilizing a keypoint deep learning network (DLN), wherein the scaled 3D model is predicted from the at least two different images utilizing the keypoint DLN, and wherein a given scale factor scales pixel dimensions in a given image to real-world dimensions of the object; and
generating one or more object measurements from the scaled 3D model.

2. The computer-implemented method of claim 1, wherein determining one or more scale factors for the plurality of images of the object comprises:
detecting two or more feature points on a ground plane on the at least two different images of the plurality of images, and
determining a scale factor for each of the at least two different images from the two or more feature points.

3. The computer-implemented method of claim 2, wherein the processor employs an augmented reality software development kit (AR-SDK) for detecting the ground plane.

4. The computer-implemented method of claim 2, wherein the one or more scale factors are calculated based on distances between at least three feature points of the ground plane.

5. The computer-implemented method of claim 1, wherein the one or more scale factors are determined using a lidar sensor.

6. The computer-implemented method of claim 1, wherein the one or more scale factors are determined using a depth sensor.

7. The computer-implemented method of claim 1, wherein generating the scaled 3D model of the object from the at least two different images of the plurality of images and their corresponding scale factors utilizing the kcypoint deep learning network (DLN) further comprises:
generating an unstructured 3D mesh of the object from the at least two different images and their corresponding scale factors using a photogrammetry process;
generating two or more 2D keypoints from the at least two different images of the object using the keypoint deep learning network (DLN), wherein the keypoint deep learning network (DLN) comprises a 2D keypoint deep learning network (DLN);
generating an annotated unstructured mesh of the object by projecting the two or more 2D keypoints onto the scaled unstructured 3D mesh of the object; and
morphing a structured 3D mesh using the annotated unstructured 3D mesh of the object to generate the scaled 3D model.

8. The computer-implemented method of claim 1, wherein generating the scaled 3D model of the object from the at least two different images of the plurality of images and their corresponding scale factors utilizing the keypoint deep learning network (DLN) further comprises:
generating an unstructured 3D mesh of the object from the at least two different images and their corresponding scale factors using a photogrammetry process;
annotating the unstructured 3D mesh by detecting two or more 3D keypoints using the keypoint deep learning network (DLN), wherein the keypoint deep learning network (DLN) comprises a 3D keypoint deep learning network (DLN); and
morphing a structured 3D mesh using the annotated unstructured 3D mesh of the object to generate the scaled 3D model.

9. The computer-implemented method of claim 1, wherein the scaled 3D model is generated using a retopology process.

10. The computer-implemented method of claim 1. wherein one or more of the image capture screens enables a user employing the mobile computing device to set a relative position between the object and the mobile computing device into one of the image capture positions.

11. The computer-implemented method of claim 10. wherein the image capture screens for setting the image capture positions comprise a position guide for positioning the object.

12. The computer-implemented method of claim 10, wherein one or more of the plurality of image capture screens enable determining an angle of the mobile computing device relative to the object in each of the image capture positions.

13. The computer-implemented method of claim 10, wherein one or more of the plurality of image capture screens enable determining whether there is movement of the mobile computing device during an image capture operation.

14. The computer-implemented method of claim 10. wherein the mobile computing device generates feedback when the mobile computing device is in a correct imaging position.

15. The computer-implemented method of claim 1, wherein the object is a body part.

16. The computer-implemented method of claim 15, wherein the body part is a human limb.

17. The computer-implemented method of claim 15, wherein the body part is selected from the group comprising a human foot and a human hand.

18. The computer-implemented method of claim 1, further comprising:
receiving a selection of an object type to be measured from a plurality of object types, wherein the image capture screens are generated based on the selected object type.

19. A non-transitory computer-readable storage medium having program instructions for obtaining measurements of objects embodied therein, the program instructions executable by a processor to cause the processor to:
generate a plurality of image capture screens for display on a mobile computing device, each image capture screen providing instructions for placing the mobile computing device in corresponding image capture positions for measurement of the object, wherein each of the plurality of image capture positions are within a predetermined angular distance around the object;
capture a plurality of images of the object corresponding to the plurality of image capture screens;
determine one or more scale factors for the plurality of images of the object;
generate a scaled 3D model of the object from at least two different images of the plurality of images and their corresponding scale factors utilizing a keypoint deep learning network (DLN), wherein the scaled 3D model is predicted from the at least two different images utilizing the keypoint DLN, and wherein a given scale factor scales pixel dimensions in a given image to real-world dimensions of the object; and
generate one or more object measurements from the scaled 3D model.

20. The non-transitory computer-readable storage medium of claim 19, wherein the program instructions to determine one or more scale factors for the plurality of images of the object comprise program instructions to:
detect two or more feature points on a ground plane on the at least two different images of the plurality of images, and
determine a scale factor for each of the at least two different images from the two or more feature points.

21. The non-transitory computer-readable storage medium of claim 20, wherein the processor employs an augmented reality software development kit (AR-SDK) for detecting the ground plane.

22. The non-transitory computer-readable storage medium of claim 20, wherein the one or more scale factors are calculated based on distances between at least three feature points of the ground plane.

23. The non-transitory computer-readable storage medium of claim 19, wherein the one or more scale factors are determined using a lidar sensor.

24. The non-transitory computer-readable storage medium of claim 19, wherein the one or snore scale factors arc determined using a depth sensor.

25. The non-transitory computer-readable storage medium of claim 19, wherein the program instructions to generate the scaled 3D model of the object from the at least two different images of the plurality of images and their corresponding scale factors utilizing the keypoint deep learning network (DLN) comprise program instructions to:
generate an unstructured 3D mesh of the object from the at least two different images and their corresponding scale factors using a photogrammetry process;
generate two or more 2D keypoints from the at least two different images of the object using the keypoint deep learning network (DLN), wherein the keypoint deep learning network (DLN) comprises a 2D keypoint Deep Learning Network (DLN);
generate an annotated unstructured mesh of the object by projecting the two or more 2D keypoints onto the scaled unstructured 3D mesh of the object; and
morph a structured 3D mesh using the annotated unstructured 3D mesh of the object to generate the scaled 3D model.

26. The non-transitory computer-readable storage medium of claim 19, wherein the program instructions to generate the scaled 3D model of the object from the at least two different images of the plurality of images and their corresponding scale factors utilizing the keypoint deep learning network (DLN) comprise program instructions to:
generate an unstructured 3D mesh of the object from the at least two different images and their corresponding scale factors using a photogrammetry process;
annotate the unstructured 3D mesh by detecting two or snore 3D keypoints using the keypoint deep learning network (DLN), wherein the keypoint deep learning network (DLN) comprises a 3D keypoint Deep Learning Network (DLN); and
morph a structured 3D mesh using the annotated unstructured 3D mesh of the object to generate the scaled 3D model.
